(19) United States
(12) Patent Application Publication
(10) Pub. No.: US 2014/0122413 A1
(43) Pub. Date: May 1, 2014

(54) BULK READ AND WRITE BETWEEN MULTI-DIMENSIONAL DATA STRUCTURES

(71) Applicant: PARIS TECHNOLOGIES, INC., Doylestown, PA (US)

(72) Inventors: Duane Edward PRESTI, Doylestown, PA (US); Roger Allen WILLSON, Wilmington, MA (US)

(73) Assignee: PARIS TECHNOLOGIES, INC., Doylestown, PA (US)

(21) Appl. No.: 14/066,213

(22) Filed: Oct. 29, 2013

Related U.S. Application Data
(60) Provisional application No. 61/719,888, filed on Oct. 29, 2012.

(51) Int. Cl. G06F 17/30

(52) U.S. Cl. CPC G06F 17/30563
USPC 707/602

(57) ABSTRACT

A system and method for reading and writing of data values between multidimensional structures that reside in Online Analytical Processing (OLAP) databases are disclosed. Data queries may be performed and updates executed between multidimensional data structures, whether existing on the same server or separate servers. Bulk (being two or more intersections) transfers are allowed between multidimensional structures (or cubes), providing a performance gain that cannot be matched using a standard point-by-point implementation. An intersection only contains a numerical or data value if there is a value for each dimension at that intersection within the database. Multidimensional data structures naturally generate sparse intersections where no data values are found, which can greatly impact performance. Within each cube, only a small intersection of members actually contains values. The system may very quickly calculate reports which include any intersection in any very large cube.

### CROSS-REFERENCE TO RELATED APPLICATIONS

This is a Non-Provisional application, which claims priority to U.S. Provisional Application Nos. 61/719,888, which were filed on Oct. 29, 2012; the contents of which are all herein incorporated by this reference in their entireties. All publications, patents, patent applications, databases and other references cited in this application, all related applications referenced herein, and all references cited therein, are incorporated by reference in their entirety as if restated here in full and as if each individual publication, patent, patent application, database or other reference were specifically and individually indicated to be incorporated by reference.

### FIELD OF THE INVENTION

The present application is directed to reading and writing of data values between multidimensional structures, and more particularly to reading and writing data values between multidimensional structures that reside in Online Analytical Processing (OLAP) databases residing on a single server or on separate servers in communication with each other.

### BACKGROUND

Multidimensional data structures and OLAP technologies are available from various sources today. Each has its own particular set of features but all are based on data structures that allow users to query (read) intersections within the structure. OLAP is a category of software technology that allows users, such as analysts, managers and executives, to gain insight into data through access to a wide variety of possible views of information that has been transformed from raw data to reflect the real dimensionality of the enterprise as understood by the user.

OLAP functionality is characterized by dynamic multi-dimensional analysis of consolidated enterprise data supporting end user analytical and navigational activities. The multidimensional structure, also called a cube, is an array of data understood in terms of its 0 or more dimensions. A cube may have any number of dimensions. Each dimension in a cube may be related to a different aspect of the data contained within the multidimensional structure. For example, in a multidimensional structure related to sales transactions, there may be a customer dimension, a product dimension, and a time period dimension. In business or sales, using cubes may allow a user to compare actual expenses with budgeted expenses. Cubes contain intersections, which are a range of data values from each dimension in the cube occurring at a particular point in the cube. In a database with a customer dimension, product dimensions, and time period dimension, an intersection value may show all sales of a specified product to a specified customer during a certain month of the year. If no customers bought the product during a certain month of the year, no value would exist at that intersection and the intersection would be considered sparse.

Some existing multidimensional data structures and OLAP technologies support dynamically updating, or writing, values into these cubes structures as well. Various technologies, including end user applications/tools, exist which allow users to generate reports from this data. Using these tools, a user can specify a database, a multidimensional structure and an intersection from which to generate a report. This report structure is generally saved in the tool and when calculated uses the current data residing at the specified intersection on the database.

However, existing OLAP databases typically involve the reading and writing data within a single multidimensional database. In current implementations of multidimensional databases, a user must generate multiple reports, with each report accessing only a single database. If an end user wishes to generate a final report that requires information not found within one multidimensional database, the user must first generate a report using the information in the database, generate a separate report by accessing a second database, and then perform additional manual processing on the two generated reports in a separate program. There is currently no system or method that allows a user to query and update between multidimensional data structures, thereby minimizing the amount of additional manual processing necessary to generate a final report.

### SUMMARY

The present application is directed to a system and method for reading and writing of data values between multidimensional structures that reside in OLAP databases. The system and method allow for performing data queries and updates that execute between multidimensional data structures, whether existing on the same server or on separate servers. The system and method allow bulk (being two or more intersections) transfers between multidimensional structures, thereby providing a performance gain that cannot be matched using a standard point-by-point implementation. An intersection only contains a numerical or data value if there is a value for each dimension at that intersection within the database. Multidimensional data structures naturally generate sparse intersections where no data values are found, and these sparse intersections can greatly impact performance. The potential size of a cube is determined by multiplying the number of members along each dimension. This size can be extremely large in a cube with just a few dimensions. Within this cube, only a small intersection of members actually contains values. The system must be able to very quickly calculate reports which include any intersection in any very large cube.

The system and method, which allow reading and writing in bulk, significantly reduce these performance implications.

By allowing the multidimensional structures to query/update between each other, system and method minimize the manual manipulation of like data that exists in different multidimensional databases. This provides the analytical performance necessary to access data within a reasonable timeframe.

The system may include a single or multiple OLAP servers, wherein each server contains at least one database. Each database may be stored within the server, or may be stored in electronic, computer readable memory accessible by the server. OLAP servers in the present invention may communicate with a user through a communication interface. The communication interface in the server receives queries from a user device, and transmits a response back to the user device.

### BRIEF DESCRIPTION OF THE DRAWINGS

FIG. 1 illustrates the transfer of data between multidimensional databases according to one aspect of the present invention.

### DETAILED DESCRIPTION

The system and method provide for bulk reading and writing of data between multiple databases running on a single server, or bulk reading and writing of data between multiple databases running on separate servers. Each server may include a server processor, a software program stored on a computer readable medium within the server storing instructions to execute read, write and communication transactions, internal communication connections, a network or external communication interface, and computer accessible memory storing the multidimensional databases. When implementing bulk reading and writing among multiple multidimensional databases residing on a single server, the processor within the server may control the transfer of requests, data flow, and responses among the databases. When implementing bulk reading and writing between multiple databases running on separate servers, the servers may communicate with each other over the external or network communication interfaces.

Each database may be a multidimensional database containing multidimensional structures, or cubes. Intersections of values within a cube are created during either read or write requests, and then those intersections are sent to a corresponding database for processing. This operation executes as a single, whole process on the corresponding database, optimally performing the necessary actions. In a database with a customer dimension, product dimensions, and time period dimension, an intersection value may show all sales of a specified product to a specified customer during a certain month of the year. If no customers bought the product during a certain month of the year, no value would exist at that intersection and the intersection would be considered sparse. All applicable calculations on the specified intersections will be performed by each database. When a read request is being processed by one database, the entire block of data will be returned and mapped to the corresponding multi-dimensional data structure in the requesting database.

The bulk reading and writing of data can be performed within a single technology, such as one software program. The single software program contains computer executable instructions relating to each multidimensional database, wherein the single software program controls read/write operations within each multidimensional database and between databases. Alternatively, the bulk reading and writing of data can be performed across technologies, such as separate software programs running on each individual server. When separate software programs are used, a software program on a first server may interact with a software program on the second server so that the first server may query the other server to access the databases therein. In this situation, the first server may act as the first database in a database chain.

An intersection of data to be transferred can be specified per read/write request as a single or multiple intersections, or the intersection may be the entire dataset. Additionally, the bulk reading and writing of data can be performed between like data structures or between different structures. Multidimensional rules and formulas can be applied to data at the source, destination or intersections within the multidimensional databases.

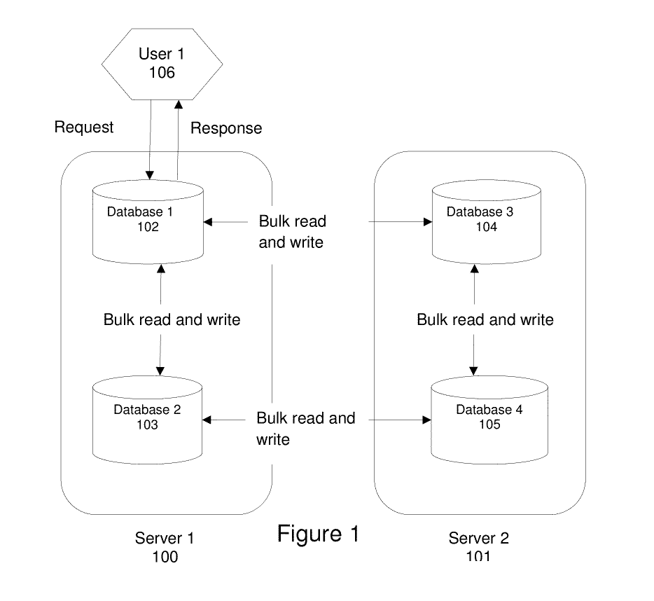

As shown in FIG. 1, the system may include multiple OLAP servers 100 and 101. Although only 2 servers and 2 databases on each server are shown in FIG. 1, the actual number of databases and servers may be unlimited. Each server 100, 101 may include memory storing a first database 102, 104 and a second database 103, 105. Each server 100, 101 may additionally include a processor to execute a software program for executing instructions to handle read/write requests from a user 106 or another server. The servers 100, 101 may include a communication interface, such as a network communication interface, for receiving requests from a user or other server and for transmitting responses to the user or other server. Each server may additionally include network communication interfaces for transmitting and receiving data within a private network, such as an intranet communication network of a business.

A bulk read operation within the system and method will now be described. A user 106 may calculate a report that requires a multidimensional data request. A user device sends this multidimensional data request to server 100, which transmits the request to database 102 stored within server 100. This request may describe a multidimensional intersection of data. Database 102 then determines the intersection of the request and decides if it needs to perform a bulk query to one or multiple multidimensional databases. If so, it creates an intersection between the values the user requested and the intersection with the other multidimensional structure defined in the current database. This is done by intersecting the members along each dimension in the cube. For each dimension, an algorithm compares the members and creates a subset of those that exist in both the requested intersection and the intersection defined in the source database. This intersection is then queried in bulk from the corresponding database(s), such as databases 103 and 104. A Single request is made to return all values. When the multiple multidimensional databases reside on a single reside server, the request would go between database 102 and database 103 as the corresponding database. When the bulk reading is being performed between databases residing on separate servers, the request may be between database 102 and databases 103, 104, and 105 as the corresponding databases. The corresponding database(s) then performs all necessary calculations including potentially querying another multidimensional database, such as database 104 querying database 105 on the second server 101. The data is returned in bulk back to the source database 102. The source database 102 then determines if additional calculations must be performed or if the data is complete. Finally, the source database 102 combines all intersections of data from all remote requests with all local calculations and returns the full multi-dimensional intersection of data to the user 106.

A bulk write operation within the system and method will now be described. A user 106 makes a request to bulk write (2 or more values) to a multidimensional database. Database 102 determines the intersection of the new values and decides if it needs to perform a bulk write to one or multiple multidimensional databases. If so, it creates an intersection between the values the user is writing and the intersection with the other multidimensional structure defined in the current database. This is done by intersecting the members along each dimension in the cube. For each dimension, an algorithm compares the members and creates a subset of those that exist in both the requested intersection and the intersection defined in the source database. These values are then sent, in bulk, through a single update to the corresponding database(s). The corresponding databases may reside on the same server, such as database 103, or may reside on a separate server 101, such as databases 104, 105. The corresponding databases update the source multidimensional structures and provide status information to the source database 102. Source database 102 generates a response, and status information is then propagated back to the user 106 via the response.

The method may be executed by a computer readable medium containing program instructions which, when executed by a processor within a server, cause the server to initiate a bulk read/write request and return a response to the user. Communications between the servers, or between the servers and the user device, may be implemented using a network communication interface. This network communication interface may allow for wired or wireless communication. Additionally, the servers may include internal communication connections and interfaces to allow communication among the various components of the server, including the processor and multidimensional databases.

1. A system for reading or writing data values residing in multidimensional structures, the system comprising:
a. at least one server, wherein the server includes a processor and memory storing at least one multidimensional database;
b. a program stored on a computer readable medium, wherein the program may access the at least one multidimensional database stored on the server;
c. a communication interface, wherein the communication interface receives bulk read or write requests and transmits responses;
d. wherein the processor and server perform bulk reading or writing between multidimensional structures.

2. The system of claim 1, wherein the at least one multidimensional database is an Online Analytical Processing database.

3. The system of claim 1, wherein the at least one server comprises two or more servers, and wherein the bulk reading or writing is performed occurs between multiple databases residing on the first and second servers.

4. The system of claim 1, wherein a single program controls the bulk reading or writing of data.

5. The system of claim 1, wherein separate, interacting programs control the bulk or writing between multidimensional structures.

6. The system of claim 3, wherein separate, interacting programs control the bulk or writing between multidimensional structures.

7. The system of claim 6, wherein each server contains one of the separate, interacting programs.

8. A method of bulk reading or writing data values residing in multidimensional structures, the method comprising:
a. receiving a read or write request;
b. creating at least one intersection of values related to the request;
c. batch sending the at least one intersection of values to a corresponding database for processing.

9. The method of claim 9, wherein the bulk reading or writing occurs between multiple databases running on a single server.

10. The method of claim 9, wherein the bulk reading or writing occurs between multiple databases running on separate servers, wherein the servers communicate over a communication interface.

11. The method of claim 9, wherein a request is initiated by receiving a report calculated by a user which makes a multidimensional request to a first database running on a server.

12. The method of claim 12, wherein the first database determines the intersection of the request and further determines if a bulk query to one or multiple other databases is required to complete the user report request.

13. The method of claim 12, wherein the first database creates a source request intersection between the values the user requested and the intersection with at least one multidimensional structure within the first database.

14. The method of claim 13, wherein the source request is queried to at least one corresponding database, and wherein an updated source request multidimensional data structures is returned to the first database from the at least one corresponding database.

15. The method of claim 14, wherein the first database generates a response from the updated multidimensional data structures, and transmits this response to the user.
